(19) United States
(12) Patent Application Publication
(10) Pub. No.: US 2012/0029794 A1
(43) Pub. Date: Feb. 2, 2012

(54) METHOD AND SYSTEM FOR CONTROLLING AN ENGINE VIA COMPRESSOR SPEED

(75) Inventors: Khizer Tufail, London (GB); Kayiu Man, Wood Green (GB); Rossella Provenzano, Billericay (GB)

(73) Assignee: FORD GLOBAL TECHNOLOGIES, LLC, Dearborn, MI (US)

(21) Appl. No.: 13/158,218

(22) Filed: Jun. 10, 2011

(30) Foreign Application Priority Data
Jul. 30, 2010 (GB) 1012770.2

(51) Int. Cl. F02D 41/00

(52) U.S. Cl. 701/108

(57) ABSTRACT

An engine air estimation method is described. In one example, an amount of air entering an engine is determined in response to a speed of a compressor. The method may be especially useful for increasing engine reliability.

### CROSS-REFERENCE TO RELATED APPLICATIONS

This application claims priority to United Kingdom Patent Application Number 1012770.2 filed Jul. 30, 2010 entitled “A METHOD AND SYSTEM FOR CONTROLLING AN ENGINE” the entire contents of which are hereby incorporated herein by reference for all purposes.

### FIELD

This description relates to engine control systems and more particularly to a method and system for controlling the operation of an internal combustion engine and in particular a diesel engine.

### BACKGROUND/SUMMARY

As is known in the art, diesel engines provide great fuel economy benefits as compared to stoichiometric spark ignited engines (e.g., gasoline internal combustion engines). As is also known in the art, it may be desirable to reduce emissions from both types of such engines. One such emission to be reduced is NOx (oxides of nitrogen). One technique used to reduce such NOx emission is Exhaust Gas Recirculation (EGR). EGR operates by recirculating engine exhaust back to the engine's intake manifold. In one example, an EGR valve disposed in a duct between the engine exhaust manifold and the engine intake manifold provides EGR to engine cylinders. To enable a flow of exhaust to pass from the exhaust manifold and into the intake manifold through the EGR valve, a differential pressure must exist across the EGR valve. An engine air intake throttle can limit air flow to engine cylinders to create a pressure in the intake manifold that is lower than the pressure in the exhaust manifold, thereby providing the requisite differential pressure across the EGR valve for EGR flow.

With a diesel engine, the power developed by the engine may be controlled by adjusting the amount of fuel injected into the engine cylinders rather than through the use of a throttle at the intake of the engine. Thus, while it may be desirable to use EGR to reduce NOx in a diesel engine, the absence of a throttle may result in insufficient differential pressure across the EGR valve to obtain adequate EGR rates for required NOx reduction. Consequently, with a diesel engine, while there may be the absence of a throttle for control of engine power, a throttle is sometimes placed in the path of the engine intake to obtain a differential pressure and hence exhaust recirculation flow across the EGR valve. Such a technique can provide EGR rates of up to 60% of the in-cylinder flow through the EGR valve

Modern diesel engines normally use an intake Mass Air Flow (MAF) sensor in the vehicle induction system for scheduling instantaneous EGR, via an Engine Control Unit (ECU). The MAF sensor may be combined with a throttle to provide a system for reducing emissions of NOx with optimum CO2 (fuel-economy) and Noise Vibration and Harshness (NVH). A typical ECU feature implementation uses a closed loop control system that is based on optimized MAF set-points and the engine MAF sensor feedback signal. A considerable calibration effort is required to populate accurate MAF sensor calibration that is compatible with the intended vehicle induction system.

The accuracy and/or performance of such a MAF sensor may deteriorate when in service due to intake-contamination, wear, or sensor drift. Any degradation in the performance of the MAF sensor may result in errors in EGR scheduling that may directly impact on the emissions of NOx and CO2 and adversely affect NVH.

In order to avoid the above deterioration in optimized emissions and NVH during the life of an engine and/or vehicle, it may therefore be desirable to provide an instantaneous value of MAF that is not susceptible to contamination and drift of the MAF sensor.

The description provides an improved method and system for establishing a value of mass air flow for use in controlling an engine without the use of a MAF sensor. According to a first aspect of the description there is provided a method for determining the mass airflow entering an engine having a rotary compressor to provide forced induction to the engine wherein the method comprises measuring the rotational speed of the compressor and using the measured compressor speed to produce a value indicative of the current mass airflow entering the engine. In other words, a value indicative of air flow into an engine is provided in response to speed of a compressor providing air to the engine air intake system.

Using the measured compressor speed to produce a value indicative of the current mass airflow entering the engine may further comprise combining the measured compressor speed with a value of compressor pressure ratio to produce the value indicative of the current mass airflow entering the engine. In other words, in one example, providing a value of air mass flow into the engine responsive to compressor speed further comprises adjusting a value of air mass flow into the engine in response to a compressor pressure ratio.

Using the measured compressor speed to produce a value indicative of the current mass airflow entering the engine may further comprise combining the measured compressor speed with a value of compressor efficiency to produce the value indicative of the current mass airflow entering the engine. In other words, in one example, providing a value of air mass flow into the engine responsive to compressor speed further comprises adjusting a value of air mass flow into the engine in response to compressor efficiency. In some examples, the compressor may be the compressor of a turbocharger. In other examples, the compressor may be a compressor of a supercharger.

According to a second aspect of the description there is provided a method for controlling an engine having a rotary compressor to provide forced induction to the engine based upon the mass airflow entering the engine wherein the mass airflow is determined using a method in accordance with said first aspect of the description.

According to a third aspect of the invention there is provided a system for controlling an engine having a rotary compressor to provide forced induction to the engine wherein the system comprises an electronic controller and a speed sensor to measure the rotational speed of the compressor wherein the electronic controller is arranged to receive a signal from the speed sensor, use the signal to produce a value indicative of the current mass airflow entering the engine and use the produced mass airflow value to control the engine. In other words, a system is provided for controlling an engine having a rotary compressor providing forced induction to the engine, the system including an electronic controller and a speed sensor to measure the rotational speed of the compressor, the electronic controller receiving a signal from the speed sensor, producing a value indicative of the current mass airflow entering the engine via the signal from the speed sensor, and controlling the engine in response to the current mass airflow.

The system may further comprise a pressure sensor to measure the pressure of the air on an outlet side of the compressor and the electronic controller is further operable to use the measured outlet pressure with a value indicative of compressor inlet pressure to produce a compressor pressure ratio and use the compressor pressure ratio with the measured compressor speed to produce a mass airflow value and use the produced mass airflow value to control the engine. In other words, the system further comprises a pressure sensor to measure the pressure of the air on an outlet side of the compressor and an electronic controller producing a compressor pressure ratio via a value indicative of compressor outlet pressure and a value indicative of compressor inlet pressure, the electronic controller further producing a mass airflow value via the compressor pressure ratio and a value indicative of compressor speed, and the electronic controller adjusting engine operation responsive to the mass airflow value.

In one example, the value indicative of compressor inlet pressure may be produced using a mapped function of compressor speed. Further, the mapped function of compressor speed may be stored as a model in a memory of the electronic controller. The electronic controller may be further operable to produce the value of mass airflow based upon predicted compressor efficiency. And, the compressor may be the compressor of a turbocharger.

The above advantages and other advantages, and features of the present description will be readily apparent from the following Detailed Description when taken alone or in connection with the accompanying drawings.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 is a schematic diagram of an engine and control system according to one aspect of the description;

FIG. 2 is a chart showing the relationship between Pressure ratio and corrected mass airflow for the turbocharged engine shown in FIG. 1;

FIG. 3 is a flowchart showing a method for determining mass airflow without the use of a MAF sensor and a method for controlling an engine using the determined mass airflow in accordance with two further aspects of the description; and

FIG. 4 is a flowchart showing a method for determining mass airflow through an engine during a condition of degradation of an air intake mounted MAF sensor.

### DETAILED DESCRIPTION

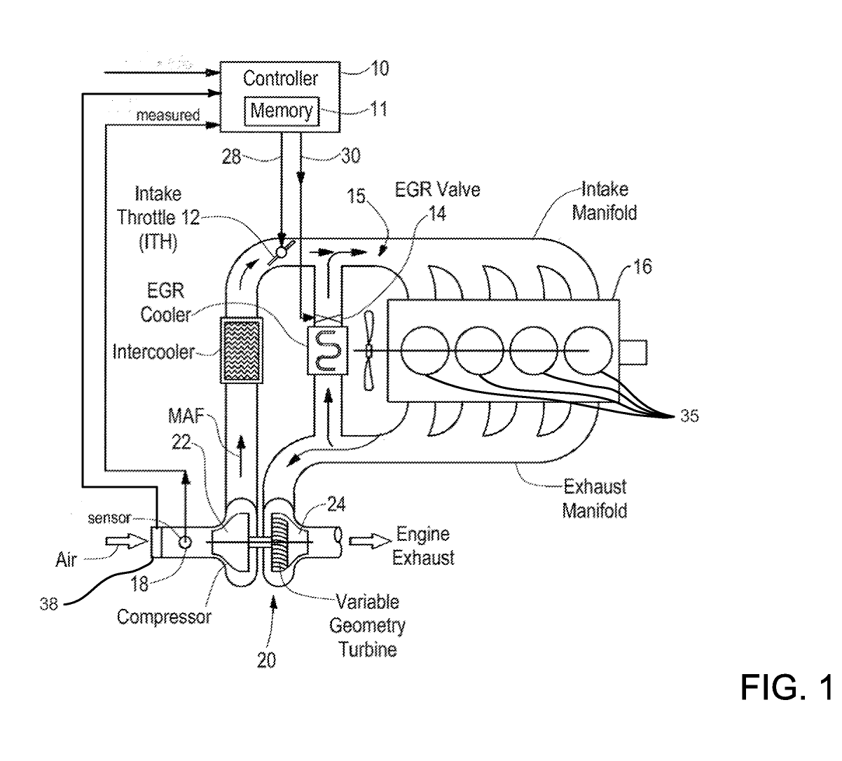

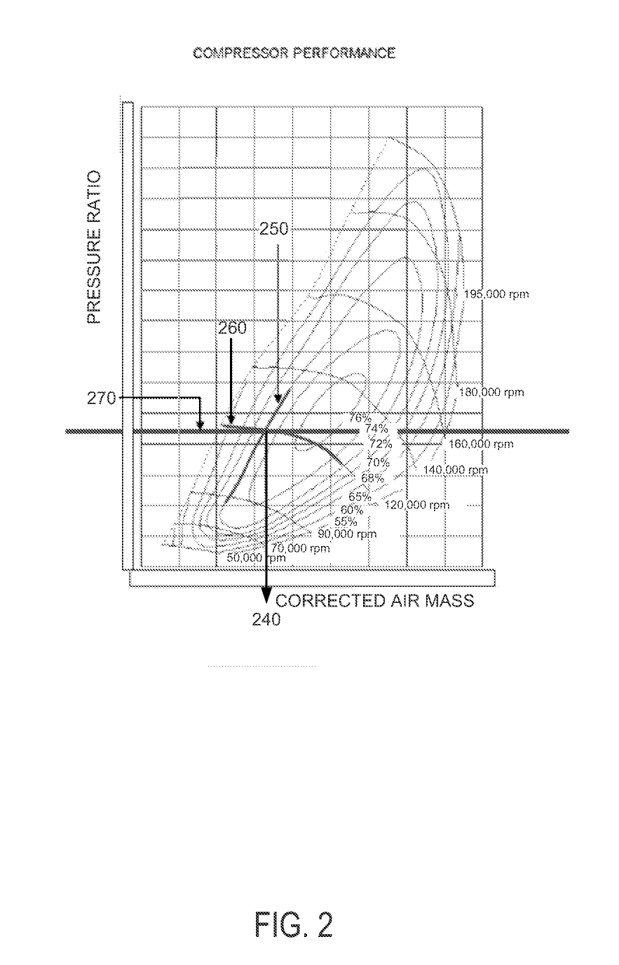

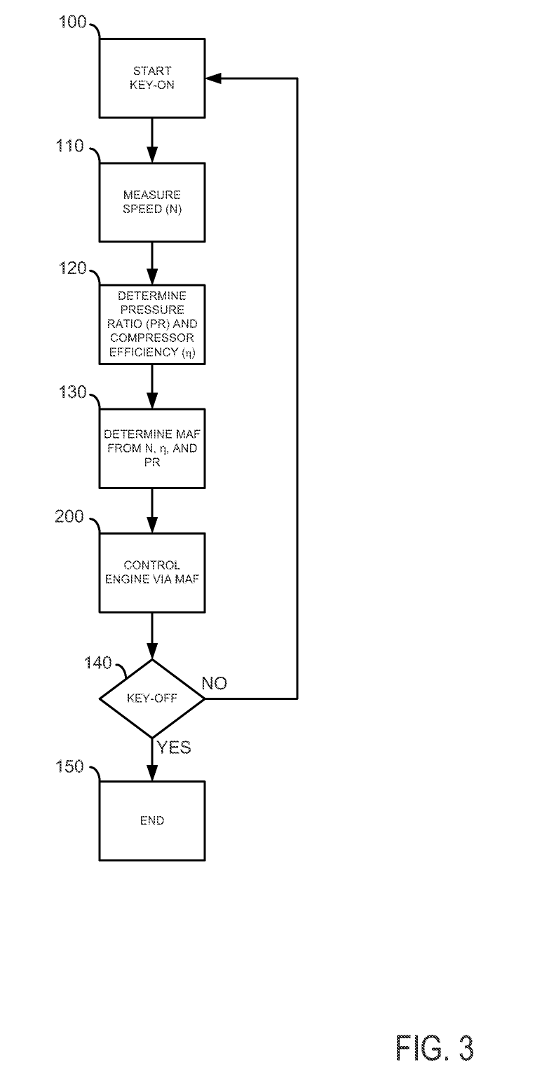

The present description is related to operating an engine in response to an engine air flow estimate based on a speed of a turbocharger compressor in communication with the engine. FIG. 1 shows an example engine that includes a turbocharger and compressor. FIG. 2 shows an example turbocharger compressor map that is a basis for estimating air flow into an engine. FIG. 3 shows a high level flowchart for controlling an engine having a compressor that is in pneumatic communication with cylinders of an engine.

Referring now to FIG. 1, an engine control system including an electronic controller 10 having a memory 11 is shown. Electronic controller 10 is used to control or adjust at least an intake throttle (ITH) 12 and an EGR valve 14 responsive to a value representing mass air flow (MAF) into an intake manifold 15 of an engine 16. The electronic controller 10 may alternatively also control fuelling of the engine 16 or perform one or more of these control functions.

The engine 16 is a diesel engine having a rotary turbo-machine in the form of a turbocharger 20 including a compressor 22 and a variable geometry turbine 24 to increase the pressure of the air fed to the engine 16 via an intake manifold 15. In other examples, the engine may be a spark ignited engine including a turbocharger or super charger with a compressor providing air to engine cylinders 35. The turbine 24 is driven by a portion of the exhaust gases from the engine 16 with the remaining portion of such exhaust gases being recirculated back to the intake manifold 15 of the engine through the EGR valve 14. A speed sensor 18 measures the rotational speed of the compressor 22 of the turbocharger 20 and supplies a signal indicative of the measured speed to the controller 10.

In some examples, engine 16 can include a MAF sensor 38. MAF sensor 38 may be located along an engine air intake system and may be exposed to engine intake air. In some examples, the MAF sensor may be a hot wire sensor. In other examples, the MAF sensor may be a pressure sensor. Output of MAF sensor 38 is transferred to controller 10.

The intake manifold 15 of the engine 16 receives air passing through the ITH 12 and exhaust gases passing through an EGR bypass passage 13 to the EGR valve 14 from an exhaust manifold 17. The amount of air passing through the ITH is a function of the position of the ITH 12 and a pressure drop across the throttle. The position of the ITH 12 varies between a fully open position and a fully closed position in response to a control signal fed to the ITH 12 from the controller 10 via line 28. Likewise, the amount of exhaust gases passing through the EGR valve 14 is a function of the position of the EGR valve 14 and a pressure drop across the EGR valve 14. The position of the EGR valve 14 varies between a fully open position and a full closed position in response to a control signal fed to the EGR valve 14 from the controller 10 via line 30.

An intercooler 8 is provided to cool the air passing into the engine 16 via the intake manifold 15 and an EGR cooler 9 is provided to cool the exhaust gas being recycled thorough the EGR bypass passage 13 and EGR valve 14.

The controller 10 also receives a number of additional inputs from sensors associated with the engine 16 such as a pressure sensor 30 measuring the outlet pressure of the compressor 22 or from operator controlled devices such as, for example, a throttle pedal position sensor (not shown). The controller 10 is operable to use these additional inputs to control the EGR flow by adjusting the position of the EGR valve 14 and the ITH 12. The electronic controller 10 forms part of a system for controlling the engine 16, the system further comprising the compressor speed sensor 18 and the compressor outlet pressure sensor 30.

The electronic controller 10 is arranged to receive a signal from the compressor speed sensor 18 indicative of the current rotational speed of the compressor 22, use the speed signal to produce a value indicative of the current mass airflow entering the engine 16 and use the produced mass airflow value (MAF value) to control the engine 16. In other words, electronic controller adjusts engine operation in response to air flowing into the engine, the air flowing into the engine based on rotational speed of compressor 22.

In some examples, the electronic controller 10 also uses the measured compressor outlet pressure from the pressure sensor 30 with a value indicative of compressor inlet pressure to produce a compressor pressure ratio (PR). In other words, a compressor pressure ratio may be provided via pressure sensor 30 and a value indicative of compressor inlet pressure. The compressor inlet pressure inlet value could be produced by the use of an inlet pressure sensor but in this example is produced by using a mapped function of compressor speed stored as a model in the memory 11 of the electronic controller 10 from which a value indicative of the compressor inlet pressure can be deduced.

A value of current compressor efficiency \dot{η} is then produced using the equations:

$$\begin{matrix}{η}_{{c}_{TS}} = \frac{{( \frac{{P}_{2}}{{P}_{01}} )}^{( γ - 1 ) / γ} - 1}{( \frac{{T}_{02}}{{T}_{01}} - 1 )} ; & ( 1 ) \\ {η}_{{c}_{TT}} = \frac{{( \frac{{P}_{02}}{{P}_{01}} )}^{( γ - 1 ) / γ} - 1}{( \frac{{T}_{02}}{{T}_{01}} - 1 )} ; and & ( 2 ) \\ Y = \frac{{C}_{p}}{{C}_{v}} & ( 3 )\end{matrix}$$

Where Cₚ is the specific heat capacity at constant Pressure; Cᵥ is the specific heat capacity at constant Volume; P₂ is the static pressure at the outlet of the compressor; P₀₁ is the total (or stagnation) pressure at the inlet to the compressor; P₀₂ is the total (or stagnation) pressure at the outlet of the compressor; T₀₁ is the total (or stagnation) temperature at the inlet to the compressor; T₀₂ is the total (or stagnation) temperature at the outlet of the compressor; η_{cTS} is the compressor Total to Static isentropic efficiency of the compressor; and η_{cTT} is the compressor Total to Total isentropic efficiency of the compressor; η is the compressor efficiency used to estimate MAF and can be calculated using equations 1 and 3 or 2 and 3. However, the total to static efficiency may be preferred over the total to total efficiency because the kinetic energy in the compressor fluid is largely dissipated in the intake manifold before it enters the engine.

The electronic controller 10 then uses the compressor speed, measured or predicted PR and the predicted compressor efficiency η to produce a value of MAF indicative of the current airflow into the engine 16. In the example described herein determination of MAF is by way of a compressor performance map stored in the memory 11 of the controller 10 and illustrated in FIG. 2.

Referring now to FIG. 2, an example compressor map is shown. The X-axis of the compressor map represents corrected mass flow through the compressor which can equate to air flow into the engine. The Y-axis of the compressor map represents pressure ratio across the compressor. Horizontal line 270 represents an example measured pressure ratio. Vertically angled line 250 represents an example estimated compressor efficiency line. Horizontal arcing line 260 represents compressor speed. Intersection 240 extended down to a value along the X-axis indicates MAF through the compressor. Thus, in this way, the compressor map of FIG. 2 can be indexed and a MAF value output.

In one example as shown in FIG. 2, the compressor map consists of: compressor efficiency contours; compressor rotational speed; compressor pressure ratio; and corrected mass airflow. Therefore, by using the location on the map where the compressor speed, pressure ratio (PR) and compressor efficiency coincide, a value of the airflow entering the engine 16 without the use of a MAF sensor is produced. For example, a compressor may stored in memory of a controller can be indexed via compressor rotational speed and compressor pressure ratio. The table is read at the indexed locations and corrected mass airflow entering the engine is output. That is to say, the controller 10 is operable to use the compressor pressure ratio (PR) with the measured compressor speed (N) and the predicted compressor efficiency (η) to produce an engine mass airflow value (MAF value) and use the produced engine mass airflow value (MAF value) to control the engine 16 in the same way as it would be controlled if the MAF were to be produced using a MAF sensor. This has the advantage that because a MAF sensor does not have to be used the disadvantages referred to above are overcome. In other words, the engine can be controlled in response to an air mass that is based on a compressor speed sensor that detects speed of a compressor.

It will be appreciated that the values of pressure ration (PR), compressor speed (N) and compressor efficiency (η) could be combined in some other way to produce the value of MAF such as for example by way of calculation using algorithms stored in the memory 11 of the electronic controller 10.

It will also be appreciated that although the description includes a turbocharger compressor, the description is not limited to such an embodiment and other means for driving the compressor could be used.

Referring now to FIG. 3, there is shown a method for determining engine MAF without the use of a MAF sensor and a method for using this MAF value to control the operation of the engine 16.

The method starts at step 100 with a key-on event such as an engine start. The method then advances to step 110 where the rotation speed (N) of the compressor 22 is measured using the speed sensor 18 and a signal indicative of this speed is provided to the electronic controller 10. The speed sensor 18 may be magnetic, optical, or laser based.

The method then advances to step 120 where the electronic controller 10 uses the signal from the compressor outlet pressure sensor 30 and a predicted value of the compressor inlet pressure using a mapped function of compressor speed to produce a value of pressure ratio (PR) and calculates using stored algorithms or by means of stored maps a value for the predicted current turbocharger compressor efficiency (η).

The method then advances to step 130 where the values for pressure ratio (PR), compressor efficiency (η) and compressor speed (N) are used to produce a value (MAF value) indicative of the current mass airflow into the engine 16. In particular, a map of compressor flow as illustrated in FIG. 2 is indexed via compressor speed and compressor pressure ratio. The map outputs a mass airflow indicative of engine mass airflow at the present engine operating conditions. In this way, an amount of air entering an engine may be estimated.

Then in step 140 it is determined whether the engine 16 is still operating and if it is (KEY-ON=YES) the method loops back to step 110. However, if the engine 16 is no longer running (KEY-ON=NO) the method ends at step 150.

FIG. 3 also includes a further method step 200 indicating that the determined value of mass airflow (MAF value) can be used to control the operation of the engine 16. It will be appreciated that such engine control would operate in the same manner as conventional engine control using MAF with the exception that the MAF has been determined without the need for a MAF sensor. Thus, engine fuel and EGR may be adjusted in response to a MAF as determined from the compressor map via compressor speed and compressor ratio. In one example, a position of an EGR valve is adjusted according to the MAF estimate output from the compressor map. Similarly, a position of a throttle and fuel injection amount may be adjusted according to the MAF estimate.

It will be appreciated that the method steps shown on FIG. 3 are by way of example and that they may be performed in a different order or combination than those shown.

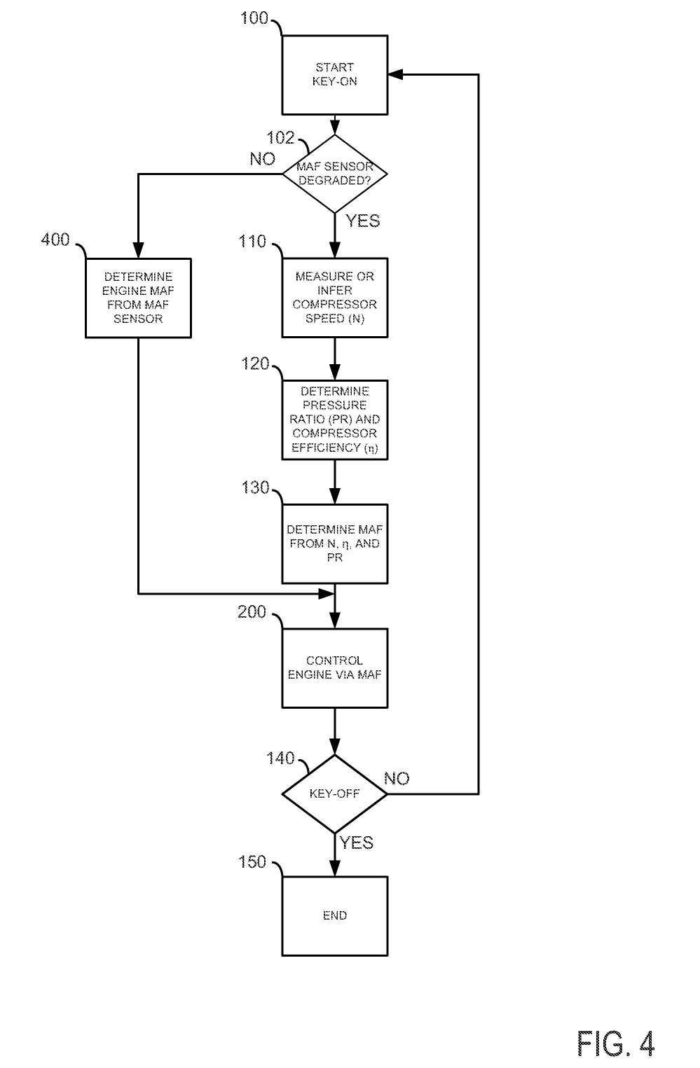

Referring now to FIG. 4, a flowchart showing a method for determining mass airflow through an engine during a condition of degradation of an air intake mounted MAF sensor is shown. The method of FIG. 4 includes numerical identifiers as described in FIG. 3. The portions of FIG. 4 that have the same identification as shown in FIG. 3 are identical with equivalently identified portions of FIG. 3. Thus, similarly labeled portions of FIGS. 3 and 4 have the same function and operate according to the description of FIG. 3. For the sake of brevity, the descriptions of portions of FIG. 4 that are identical to portions of FIG. 3 are omitted.

At 102, the method of FIG. 4 judges whether or not MAF sensor degradation is present. In one example, the MAF sensor is located along an engine air intake system and degradation is determined via comparing the output of the MAF sensor with expected MAF sensor outputs stored in memory of a controller. If MAF sensor degradation is determined, the method of FIG. 4 proceeds to 110 where compressor speed is determined. If MAF sensor degradation is not determined, the method of FIG. 4 proceeds to 400 where engine MAF is determined from a MAF sensor. In one example, a voltage or current output from a MAF sensor is determined or measured via a controller. The sensor may be exposed to air entering the engine. In one example, the MAF sensor is a hot wire sensor. In another example, MAF may be determined from a MAP sensor and engine speed. The voltage or current is converted to an engine air mass that describes an amount of air entering engine cylinders. The method of FIG. 4 proceeds to 200 after engine MAF is determined.

At 200, the method of FIG. 4 controls the engine via a MAF value as determined from a MAF sensor positioned in the engine intake system. Alternatively, if the MAF sensor is degraded, the engine is controlled without the MAF sensor via MAF determined without the MAF sensor. The method of FIG. 4 proceeds to 140 after engine operation is adjusted according to engine MAF.

In this way, it is possible to adjust engine operation via an engine MAF as determined from a MAF sensor located along an engine air intake, or alternatively, engine operation may be adjusted without the MAF sensor according to an estimated MAF that may be determined via a compressor speed.

Controller 10 of FIG. 1 may include instructions for executing the methods of FIGS. 3 and 4. Further, controller 10 may include a compressor map as illustrated in FIG. 2 for estimating air flowing into an engine.

It will be appreciated by those skilled in the art that although the invention has been described by way of example with reference to one or more embodiments it is not limited to the disclosed embodiments and that one or more modifications to the disclosed embodiments or alternative embodiments could be constructed without departing from the scope of the invention as set out in the appended claims.

As will be appreciated by one of ordinary skill in the art, the methods described in FIGS. 3 and 4 may represent one or more of any number of processing strategies such as event-driven, interrupt-driven, multi-tasking, multi-threading, and the like. As such, various steps or functions illustrated may be performed in the sequence illustrated, in parallel, or in some cases omitted. Likewise, the order of processing is not necessarily required to achieve the objects, features, and advantages described herein, but is provided for ease of illustration and description. Although not explicitly illustrated, one of ordinary skill in the art will recognize that one or more of the illustrated steps or functions may be repeatedly performed depending on the particular strategy being used.

This concludes the description. The reading of it by those skilled in the art would bring to mind many alterations and modifications without departing from the spirit and the scope of the description. For example, single cylinder, I2, I3, I4, I5, V6, V8, V10, V12 and V16 engines operating in natural gas, gasoline, diesel, or alternative fuel configurations could use the present description to advantage.

1. A method for determining mass airflow entering an engine, comprising:
providing an estimate of air mass entering an engine via a speed of a compressor supplying air to the engine.

2. The method of claim 1, further comprising adjusting the estimate of air mass entering the engine via a pressure ratio across the compressor supplying air to the engine.

3. The method of claim 1, further comprising adjusting the estimate of air mass entering the engine via an efficiency of the compressor supplying air to the engine.

4. The method of claim 1, where the compressor is a compressor of a turbocharger.

5. The method of claim 1, further comprising adjusting engine operation in response to the estimate of air mass entering the engine.

6. The method of claim 1, where the estimate of air mass entering the engine is based on a map of the compressor supplying air to the engine.

7. A method for determining mass airflow entering an engine, comprising:
during a first mode, providing an estimate of air mass entering an engine via a sensor located along an engine air inlet path, the sensor exposed to air entering the engine; and
during a second mode, providing an estimate of air mass entering an engine via a speed of a compressor supplying air to the engine.

8. The method of claim 7, where the second mode is a mode where degradation of the sensor located along an engine air inlet path occurs.

9. The method of claim 7, where the estimate of air mass entering the engine during the second mode is adjusted in response to a pressure ratio across the compressor.

10. The method of claim 7, where the speed of the compressor is based on a magnetic or optical speed sensor.

11. The method of claim 7, where the MAF sensor is a hot-wire sensor.

12. A system for controlling an engine, comprising:
a speed sensor of a compressor; and
a controller, the controller including instructions for estimating air flow to an engine in response to the speed sensor of the compressor.

13. The system of claim 12, where the controller adjusts at least one of a throttle and an EGR valve in response to the estimated air flow.

14. The system of claim 12, further comprising a pressure sensor positioned proximate the compressor, and the controller including additional instructions for adjusting the estimate of air flow to the engine in response to the pressure sensor.

15. The system of claim 14, further comprising additional controller instructions for determining a pressure ratio across the compressor and adjusting the estimated of air flow to the engine in response to the pressure ratio.

16. The system of claim 16, further comprising additional controller instructions for determining an efficiency of the compressor and adjusting the estimated of air flow to the engine in response to the efficiency of the compressor.

17. The system of claim 12, further comprising an engine air intake throttle and additional controller instructions for adjusting a position of the engine air intake throttle in response to the estimated air flow to an engine.

18. The system of claim 12, further comprising an EGR valve and additional controller instructions for adjusting a position of the EGR valve in response to the estimated air flow to an engine.
